(19) United States
(12) Patent Application Publication
(10) Pub. No.: US 2026/0316645 A1
(43) Pub. Date: Oct. 15, 2026

(54) SEAT CUSHION ARRANGEMENT AND VEHICLE SEAT

(71) Applicant: Adient US LLC, Plymouth, MI (US)

(72) Inventor: Bernard GILMORE, Burscheid (DE)

(21) Appl. No.: 19/644,206

(22) Filed: Apr. 10, 2026

(30) Foreign Application Priority Data
Apr. 10, 2025 (DE) 10 2025 114 188.6

(51) Int. Cl. B60N 2/64; B60N 2/52; B60N 2/54

(52) U.S. Cl. CPC B60N 2/646; B60N 2/527; B60N 2/54

(57) ABSTRACT

A seat cushion arrangement, in particular for a vehicle seat, may have a seat cushion element having an at least approximately horizontal seat surface, which element has at least one recess arranged in the seat surface. The arrangement may also have a support arrangement. The support arrangement may have at least one ergonomically shaped relief element which is mounted movably at least in the vertical direction in the at least one recess of the seat cushion element. A vehicle seat with such a seat cushion arrangement is also provided.

### FIELD

The invention relates to a seat cushion arrangement, in particular for a vehicle seat, and to a vehicle seat.

### BACKGROUND

US 9 802 521 B2 discloses a multi-layer vehicle seat with inflatable air bladders for adjusting the firmness of a seat cushion and a backrest. A vehicle seat arrangement comprises a multi-layer arrangement which further comprises a spring layer with tunable springs, a flexible plate supported by the spring layer, a bladder arrangement arranged on the flexible plate, a thin foam layer arranged above the bladder arrangement, and a frame-supported carrier, in which the spring layer is embedded.

US 10 286 818 B2 discloses a vehicle seat arrangement with a backrest and a seat surface. The seat surface is functionally connected to the backrest. The seat base comprises a first spring assembly. The first spring assembly comprises a spring element functionally connected to a seat surface, one or more adjustable springs arranged over the seat surface, flexible side bolsters of the seat surface, a seat cushion arrangement arranged above the spring element, and articulated seat side bolsters of the seat cushion arrangement. The seat base also comprises a second spring assembly. The second spring assembly comprises a plurality of independent thigh supports which are functionally connected to a front part of the seat surface.

US 9 108 553 B2 discloses a vehicle seat spring assembly comprising a rear support for engagement with a torsion tube of a vehicle seat. End portions of first and second spring elements are connected to the rear support. Each of the first and second spring elements is fitted with intermediate cushion shell connection pieces. A transverse strut is coupled to the first and second spring elements and has openings for power and data cabling.

US 2010/237082 A1 discloses a pad with a layer of elastic gel arranged on a foam layer. The gel layer of the pad can have geometric recesses such as creases, grooves, ripples, corrugations, a pointed shape, or any desired combination thereof. The geometric cut portions can be round, square, trapezoidal, triangular, rectangular, rectangular with rounded corners, semi-circular or in any desired combination. The geometric cutouts can also be hollow to further reduce the gel content. The shape of the gel layer can differ from or be independent of the shape of any points or geometric cut portions in the foam layer. In addition, the foam layer of the cushion can have a geometric shape, and geometric cutouts can have, for example, a pointed, folded, grooved, rippled, corrugated shape or any desired combination thereof. The geometric cut portions can be round, square, trapezoidal, triangular, rectangular, rectangular with rounded corners, semi-circular or in any desired combination. In order to further reduce the foam content, the geometric cutouts can also be hollow. The gel layer can be fused to, glued to or molded together with the foam layer. The layers can be combined or joined to create flat surfaces on flat surfaces, pointed surfaces on pointed surfaces (for example, nested or interlocking), or pointed surfaces on flat surfaces. All of these combinations provide different levels of support and cushioning to the end user. In addition, it is possible to offer different cushion effects or support effects on both sides, thus enabling a reversible function of the cushion in order to meet the level of support and comfort desired by the user. The covers of the mat can also have different colors and textures.

US 2017/065085 A1 discloses an improved foam seat cushion which is ergonomically shaped and equipped with a notch to facilitate proper seating and for potential centering on a seat, as well as multiple cooling channels running through the cushion. In some cases, the foam seat cushion has handles attached on both sides and can be folded in the center for simple transport. In some further examples, the foam seat cushion comprises a layer of padding arranged above the foam layer. The foam seat cushion consists of a foam layer having an upper side, a lower side, a first front side, a first back side and a plurality of edge sides; it has a notch which is arranged approximately in the middle of the first back side, runs between the upper side and lower side of the foam layer and extends from the first back side in the direction of the middle of the foam layer in order to partially halve the foam layer and create a notch side perpendicular to the upper side and lower side; a multiplicity of channels running through the foam layer, with openings on the upper side and lower side; and an air-permeable and moisture-permeable, removable, custom-fit cover with at least one compartment for enclosing the foam layer.

WO 01/28388 A1 has disclosed a seat with various auxiliary seat cushions in order to prevent seat pain.

### SUMMARY

The object of the invention is to improve a seat cushion arrangement of the type mentioned in the introductory part, in particular to design it in such a way that, when the seat cushion arrangement is used by a user sitting on it, the maximum pressure on the surface is reduced, the total contact surface area is increased and the average pressure on the surface of the seat cushion element is reduced, and to provide an appropriate vehicle seat.

This object is achieved according to the invention by a seat cushion arrangement, which is suitable, in particular, for a vehicle seat, and which comprises at least the following:
- a seat cushion element comprising an at least approximately horizontal seat surface and at least one recess arranged in the seat surface, and
a support arrangement, wherein the support arrangement comprises at least one support element, which is formed as a suspension mat which is arranged below the seat cushion element, and at least one, in particular ergonomically shaped, relief element, which is mounted in the at least one recess of the seat cushion element such that it can be moved at least in the vertical direction.

The designations "horizontal" and "vertical" refer here to a Cartesian coordinate system, in which the x-axis designates a longitudinal direction from the perspective of a user of the seat cushion arrangement, the y-axis designates a transverse direction and the z-axis designates a vertical direction. This makes the x-y plane a horizontal plane.

According to the invention, a recess is provided in the seat cushion element or made in the seat cushion element, and the relief element is arranged in the recess. The relief element is, in particular, ergonomically shaped, that is to say it is shaped and placed in the seat surface in such a way that it can act at the points where, when a conventional seat cushion arrangement is used by a human user, increased pressure is exerted on the body of the user. These points are especially those where the ischial tuberosities press on the seat surface or/and are the point below the coccyx.

According to the invention, the relief element is vertically movable in the recess; that is to say, it can yield to a pressure applied in the vertical z-direction. In particular, the relief element can yield to the pressure applied in the z-direction (also called vertical direction or perpendicular direction) either by deformation of the relief element, for example by compression or/and by deflection, or by a downwardly directed yielding movement of the relief element, or by a combination of a deformation and a yielding movement.

By virtue of the fact that the relief element is, in particular, ergonomically shaped, and by virtue of the fact that the relief element is arranged vertically movably in the recess of the seat cushion element, it is possible to equip a seat, for example a vehicle seat, with a separate load-bearing component in the region of the maximum load-bearing capacity of the seat cushion (that is, under the ischial tuberosities). This component is advantageously dimensioned and positioned such that it is suitable for all body sizes from P05 female to P95 male. Functionally, this component will help reduce the peak pressure at the contact surface area (up to 30%), increase the total contact surface area, and reduce the average pressure at the contact surface area on the upper side of the seat cushion.

In addition, the at least one support element is formed as a suspension mat, in particular as an elastic support bracket, and is arranged below the seat cushion element. In particular, the suspension mat is designed to be so elastic or flexible that the seat cushion element is designed to be relatively movable in its entirety, in particular to be flexible, elastic or resilient.

Advantageous refinements, which can be used individually or in combination with each other, are the subject matter of the subclaims.

In a seat cushion arrangement of the proposed type, it can be provided that the recess is designed, for example, as a depression of the seat surface of the seat cushion element. In one alternative refinement, it can be provided that the recess extends in the seat cushion element at least partially or completely in the vertical direction. Firstly, a greater vertical movement of the relief element is made possible by a complete extent of the recess, and, secondly, the relief element can be moved vertically upward again in this manner by a restoring force emanating from the lower side of the seat cushion element, which force can be generated, for example, by a spring element, when the relief element is no longer loaded from the seat surface.

In addition, one variant can provide a double foam hardness and double foam density, in which the recess or depression does not fully penetrate or does not fully extend into the seat cushion element. In this case, the relief element can additionally be fastened to the seat cushion element via local ribs and/or struts.

In one advantageous refinement of the seat cushion arrangement according to the invention, it can be provided alternatively or additionally that, in a plan view of the seat surface of the seat cushion element, the at least one relief element has an at least approximately 8-shaped outer contour and is arranged in a corresponding, at least approximately 8-shaped recess of the seat cushion element. The term "8-shaped contour" used here refers to a geometric shape reminiscent of the number 8. Alternatively, the relief element can also have the shape of a loop or the shape of a butterfly or bird, wherein the wings are preferably of oval design and extend further to the rear or to the front. Other alternative shapes for the relief element are also possible.

Such a geometric shape can be formed, for example, by connecting two circular or oval shapes to one another by a narrow connecting portion, or by positioning two circular shapes or oval shapes relative to each other in such a way that they partially overlap each other. Such an 8-shaped or loop-shaped outer contour as the shape of a relief element is suitable, in particular, for effectively relieving two areas subjected to high pressure, for example the support points of the two ischial tuberosities of a person on the seat surface of the seat cushion element and its surroundings, if the seat surface in these areas is formed by an 8-shaped or loop-shaped relief element which is vertically movable. In order that no undesirable gaps arise in the seat surface of the seat cushion element, the recess arranged in the seat cushion element advantageously also has an 8-shaped contour, the size of which corresponds approximately to that of the relief element.

In a further example, it can be provided that the side flanks of the relief element run in a straight line. Correspondingly, the recess in the seat cushion element can have a straight inner wall. The side flanks of the relief element are arranged parallel to the inner wall of the recess here. Alternatively, the at least one relief element can have oblique side flanks, whereby the relief element tapers downward, and the recess of the seat cushion element has corresponding oblique side flanks. By the downward taper of the relief element and of the recess, the vertical downward movement of the relief element is opposed by a resistance, which prevents slippage of the relief element. However, due to the elastic properties of the seat cushion element and the relief element, the relative movement of the relief element relative to the seat cushion element caused by the pressure acting on the relief element under load from above remains possible.

The relief element can, for example, consist of an elastic, in particular open-pored, foam. Alternatively, the relief element can be designed as a cushion filled with an elastic, in particular open-pored, plastic foam or as a cushion filled with liquid or as a gel-filled cushion. Such a cushion can, for example, have a gas-tight and liquid-tight enveloping element, in which the plastic foam or the liquid or the gel is arranged. It can be particularly advantageously provided that an inner pressure prevailing in the cushion is variably adjustable as required, for example by air being blown into the enveloping element or air being extracted or discharged from the enveloping element. As a result, the hardness and the height of the relief element can be adjusted to the weight of a user, for example, as required.

In addition, it can be provided that the respective variant filled with synthetic foam can either be partially evacuated or inflated, and/or that the volume or the pressure of the cushion or enveloping element can be increased or reduced as required in the respective variant filled with liquid.

In addition, it can be advantageously provided, in particular in the case of a foam relief element, that the relief element has a higher or lower density than the seat cushion element. It can also be provided that the relief element has a higher or lower hardness than the seat cushion element.

In a further exemplary refinement of the seat cushion arrangement according to the invention, it can be provided that the seat cushion arrangement has a support element arranged under the seat cushion element and extending at least approximately horizontally. In particular, the suspension mat can be designed as a flat support element and can form an elastic support bracket for the seat cushion element. For example, a first suspension mat can be designed as a spring base. A second suspension mat can be designed, for example, as a flatly stretched, flexible membrane, in particular a flexible textile mat, a flexible plastic mat or the like. Here, the support arrangement can comprise only the first suspension mat, only the second suspension mat or both suspension mats, which are arranged, in particular, on top of each other. The respective support element designed as suspension mat or both support elements designed as suspension mats are, in particular, configured to support the seat cushion element and the relief element in the vertical direction, in particular flatly resiliently.

The support element, in particular the first suspension mat, can comprise, for example, a spring base, in particular an arrangement of wire-spring elements. Advantageously, the support element can alternatively or additionally comprise a horizontally, that is to say, at least approximately in an x-y plane, stretched, flexible membrane, in particular as a second suspension mat, which can, for example, be made of a woven fabric, a plastic or a combination of a woven fabric with a plastic. The respective support element is arranged and designed in such a way that it supports the seat cushion element and the relief element in the vertical direction. Depending on the construction of the seat cushion arrangement, this can also comprise only one of the suspension mats, either only the first suspension mat or only the second suspension mat. If only the second suspension mat is provided, which is formed as a flatly stretched, flexible membrane, the seat cushion arrangement has a smaller thickness than a seat cushion arrangement, which has only the first suspension mat, which is formed as a spring base.

One development provides that the respective support element has at least one cutout. The respective support element can also be formed without a cutout and can have a continuous surface. In particular, the respective support element can have at least a first cutout in an ischial tuberosity region and at least a second cutout in a coccyx region. For example, the first cutout can comprise at least one passage opening, in particular an 8-shaped or loop-shaped, passage opening or two circular or oval passage openings spaced apart from each other. The second cutout can, for example, be formed as a conical, triangular, u-shaped or semicircular cut portion, as a slot or the like. In particular, the second cutout can be formed perpendicularly with respect to the two passage openings. The second cutout can also be arranged centrally with respect to a longitudinal axis of the suspension mat. Here, the two passage openings can be arranged spaced apart from the longitudinal axis and in a line.

In addition, the respective support member can comprise a first, for example a front, fastening unit and a second, for example rear, fastening unit and a flexible support region lying in between. For example, the respective fastening unit can extend in each case over a width of the suspension mat. Alternatively, the respective fastening unit can extend laterally, such that the support element can be mounted transversely.

Here, it can be further provided by way of example that the support element has a cutout in the region of the at least one recess of the seat cushion element. Cutouts in this sense can be designed, in particular, as openings of the support element. For example, such openings are smaller than the relief element arranged thereabove. Different combinations of holes or cut portions in the mat allow the pressure relief of different bony protrusions.

According to the invention, the object is also achieved by a vehicle seat having a seat part and a backrest, in which the seat part has a seat cushion arrangement according to the invention.

A vehicle seat is proposed which reduces the pressure resulting, in particular, on bony protrusions of a user from local weight loading, in particular under the ischial tuberosities or/and under the coccyx of a user by a vertically movable relief element inserted into a seat cushion element, which can be, for example, a specially developed 8-shaped or loop-shaped foam element.

In certain refinements, a thin membrane suspension mat or foil suspension mat and/or a spring base can be arranged as support element under the seat cushion element. In further refinements, the respective support element can have a hole or different combinations of holes or cut portions, which can reduce the pressure on different bony protrusions of a user. In particular, either the first suspension mat or the second suspension mat can be arranged below the seat cushion element. Alternatively, both suspension mats can also be arranged on top of each other and below the seat cushion element.

The concept of a relief element in a recess of a seat cushion element, which is arranged vertically movably, also works when it is used as a support element on a seat with a sinusoidal spring base or a solid shell made of metal or plastic or a seat frame.

In particular, the two support elements are, or the at least one support element is, arranged below the seat cushion element. The support element, each designed as a suspension mat, forms, in particular, an elastic support bracket for the seat cushion element with the relief element arranged movably therein.

The seat can have a conventional backrest with adjustable backrest or a fixed backrest without adjustable backrest. The invention is also advantageously usable for seats with conventional mechanisms for height adjustment and longitudinal adjustment without any compromises.

In summary and in other words, the invention provides a seat cushion arrangement and a vehicle seat which, by simple means, reduce the maximum pressure on the surface of a seat cushion element, increase the total contact surface area and reduce the average pressure on the surface of the seat cushion element, which makes sitting on the seat cushion arrangement more comfortable for a user.

### DESCRIPTION OF THE FIGURES

In the following text, the invention is explained in greater detail using advantageous exemplary embodiments illustrated in the figures. However, the invention is not limited to these exemplary embodiments. In the figures:

FIG. 1: shows a schematic illustration of a vehicle seat with a longitudinal adjustment device according to the prior art,

FIG. 2: shows a perspective view of a seat cushion arrangement of a vehicle seat according to the prior art,

FIG. 3: shows a perspective view of a seat cushion arrangement according to the invention according to a first exemplary embodiment,

FIG. 4: shows a plan view of the seat cushion arrangement according to the first exemplary embodiment,

FIG. 5: shows a perspective view of a support element according to the invention,

FIG. 6: shows a plan view of the support element from FIG. 5,

FIG. 7: shows a plan view of a further example of a support element according to the invention,

FIG. 8: shows a plan view of a seat cushion arrangement according to the invention according to a second exemplary embodiment,

FIG. 9: shows a perspective view of a spring base as first suspension mat of a third exemplary embodiment of the seat cushion arrangement,

FIG. 10: shows a perspective view of the spring base and a membrane as a second suspension mat of the third exemplary embodiment,

FIG. 11: shows a perspective view of the spring base and the membrane of the third exemplary embodiment,

FIG. 12: shows a perspective view of the spring base, the membrane and a relief element of the third exemplary embodiment,

FIG. 13: shows a perspective view of a seat cushion element and the relief element of the third exemplary embodiment,

FIG. 14: shows a plan view of the seat cushion arrangement of the third exemplary embodiment,

FIG. 15: shows a sectional illustration of the seat cushion arrangement of the third exemplary embodiment in the region of the relief element before a use of the seat surface of the seat cushion element, and

FIG. 16: shows a sectional illustration of the seat cushion arrangement of the third exemplary embodiment in the region of the relief element during a use of the seat surface of the seat cushion element.

### DETAILED DESCRIPTION

Parts which correspond to each other are provided with the same designations in all figures.

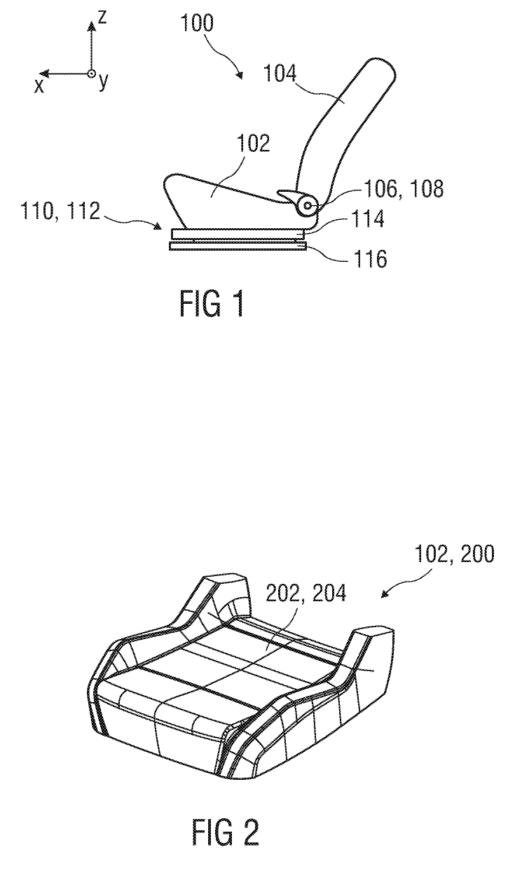

A vehicle seat 100 schematically illustrated in FIG. 1 in respect of the prior art is described below using three spatial directions which run perpendicularly with respect to each other. A longitudinal direction x extends, in a vehicle seat 100 installed in the vehicle, largely horizontally and preferably parallel to a vehicle longitudinal direction, which corresponds to the normal direction of travel of the vehicle. A transverse direction y running perpendicularly with respect to the longitudinal direction x is also oriented horizontally in the vehicle and runs parallel to a transverse direction of the vehicle. A vertical direction z runs perpendicularly with respect to the longitudinal direction x and perpendicularly with respect to the transverse direction y. In a vehicle seat 100 installed in the vehicle, the vertical direction z preferably runs parallel to a vehicle vertical axis.

The position information and direction information used, for example front, rear, top and bottom, refer to a viewing direction of an occupant seated in the vehicle seat 100 in the normal seating position, wherein the vehicle seat 100 is installed in the vehicle, in a use position suitable for passenger transport with upright backrest 104 and as usual is oriented in the direction of travel. However, the vehicle seat 100 can also be installed or moved in a different orientation, for example transversely with respect to the direction of travel. Unless otherwise described, the vehicle seat 100 is constructed mirror-symmetrically with respect to a plane running perpendicularly with respect to the transverse direction y.

The backrest 104 can be arranged pivotably on a seat part 102 of the vehicle seat 100. To this end, the vehicle seat 100 can optionally comprise a fitting 106, in particular a setting fitting, rotating fitting, latching fitting or tumbling fitting.

The position information and direction information used, for example radial, axial and in the circumferential direction, refer to a rotational axis 108 of the fitting 106. Radial means perpendicular with respect to the rotational axis 108. Axial means in the direction of or parallel to the rotational axis 108.

The vehicle seat 100 can optionally comprise a longitudinal adjustment device 110. The longitudinal adjustment device 110 comprises, for example, a rail arrangement 112 having a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example a vehicle floor.

For improved clarity, the first rail element 114 is referred to as upper rail 114 in the following description. This upper rail 114 (also called running rail or carriage) is assigned to the vehicle seat 100 and is configured to support this vehicle seat 100. The second rail element 116 is referred to as lower rail 116 in the following text. The lower rail 116 is connected fixedly and, for example, to the floor of a vehicle.

A seat cushion arrangement 200 schematically illustrated in FIG. 2 in respect of the prior art, which belongs to the seat part 102 of a vehicle seat 100 (not shown), comprises a seat cushion element 202 with an at least approximately horizontal seat surface 204.

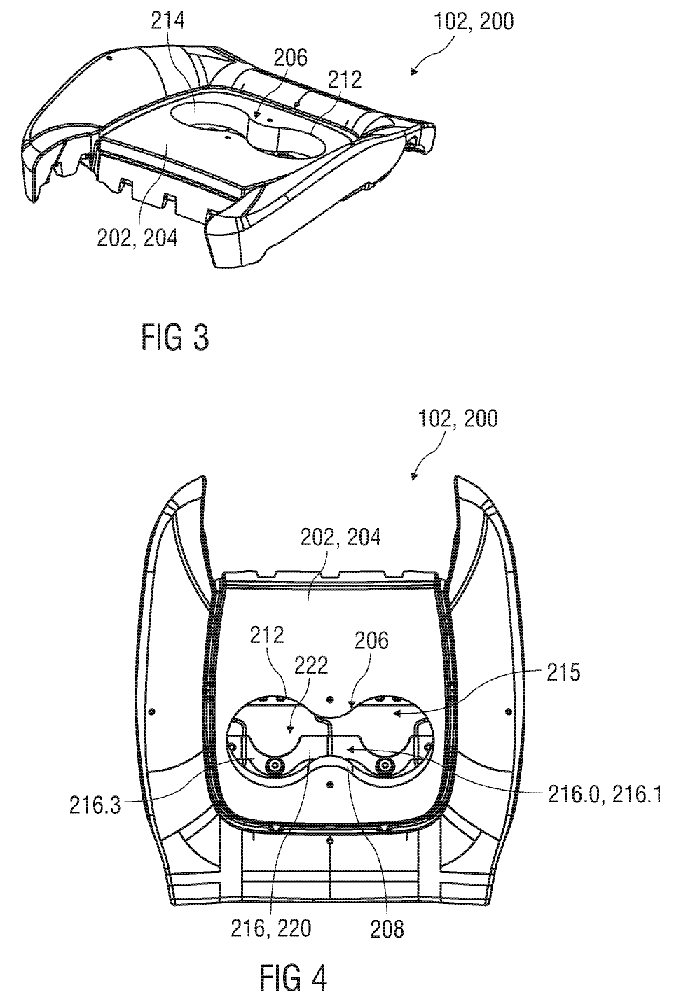

FIGS. 3 and 4 show a first exemplary embodiment of a seat cushion arrangement 200 according to the invention, which belongs to the seat part 102 of a vehicle seat 100. As known from the prior art, this seat cushion element 202 also comprises an at least approximately horizontal seat surface 204.

The seat cushion element 202 has a recess 206 arranged in the seat surface 204. The recess 206 completely penetrates the seat cushion element 202 in the vertical direction z. The recess 206 of the seat cushion element 202 has, for example, an outer contour 212 which is 8-shaped, loop-shaped or the like, optionally with straight side flanks 214.

In addition, the seat cushion arrangement 200 comprises a support arrangement 215. The support arrangement 215 of the seat cushion arrangement 200 is formed, in particular, in multiple parts.

The support arrangement 215 comprises at least one support element 216 and at least one relief element 210. The at least one support element 216 is formed as a suspension mat 216.0, which is arranged below the seat cushion element 202. In particular, the suspension mat 216.0 is designed to be elastic or flexible such that the seat cushion element 202 is designed to be relatively movable as a whole, in particular to be flexible, elastic or resilient. To this end, the respective suspension mat 216.0 is formed as an elastic support bracket 216.3.

The at least one relief element 210 is, in particular, ergonomically shaped. The at least one relief element 210 is also mounted movably at least in the vertical direction z in the at least one recess 206 of the seat cushion element 202.

The at least one support element 216 arranged under the seat cushion element 202 is of flat design. The at least one support element 216 extends approximately horizontally.

FIG. 4 shows a first example of the at least one support element 216, which is formed as a first suspension mat 216.1. The first suspension mat 216.1 can be designed, for example, as a horizontally stretched spring base 220, which supports the seat cushion element 202 in the vertical direction z and which forms the elastic support bracket 216.3. Below the recess 206 of the seat cushion element 202, the support element 216 can have cutouts 222.

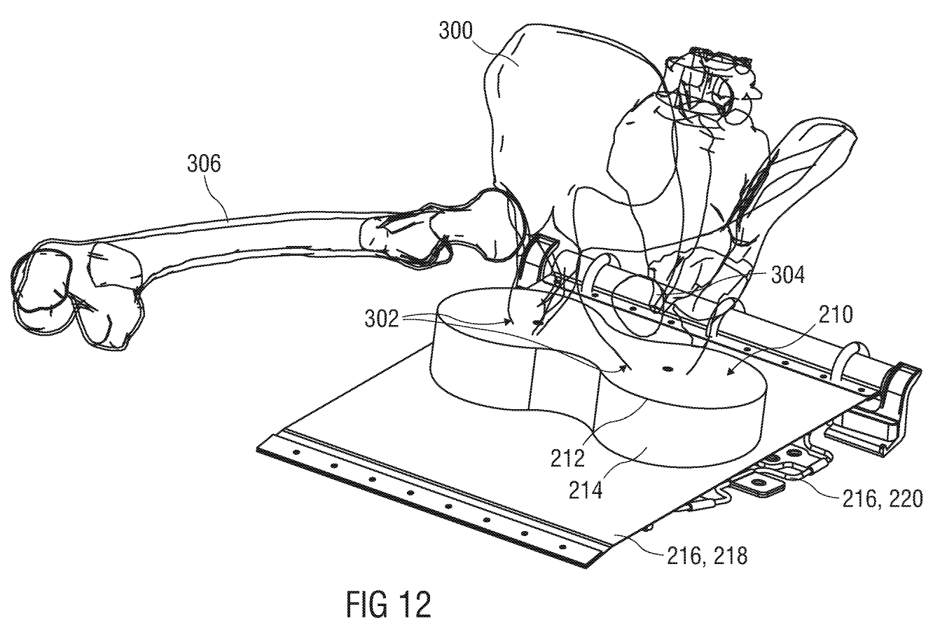

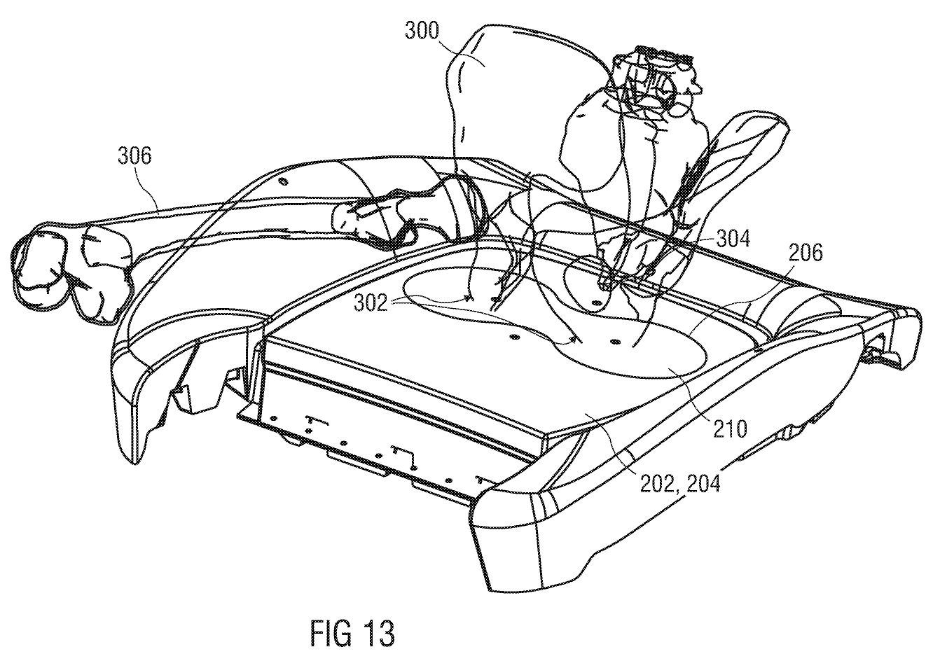

The support arrangement 215 of the seat cushion arrangement 200 further comprises the at least one, in particular ergonomically shaped, relief element 210, which is mounted movably in the vertical direction z in the at least one recess 206 of the seat cushion element 202 and is shown in FIG. 12. For example, the relief element 210 can have an 8-shaped outer contour 212, which is of corresponding design to the recess 206, such that the relief element 210 fits exactly into the recess 206, as shown in FIG. 13.

FIGS. 5 to 7 show a second example of the support element 216, which is formed as a second suspension mat 216.2, which forms an elastic support bracket 216.3. The second suspension mat 216.2 is designed, in particular, as a membrane 218 made of a flexible, flat material.

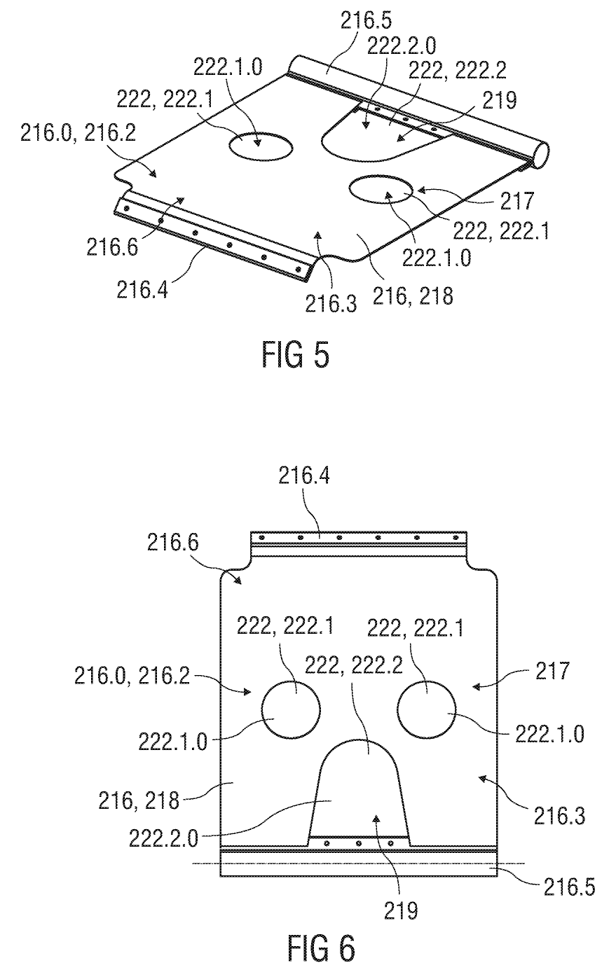

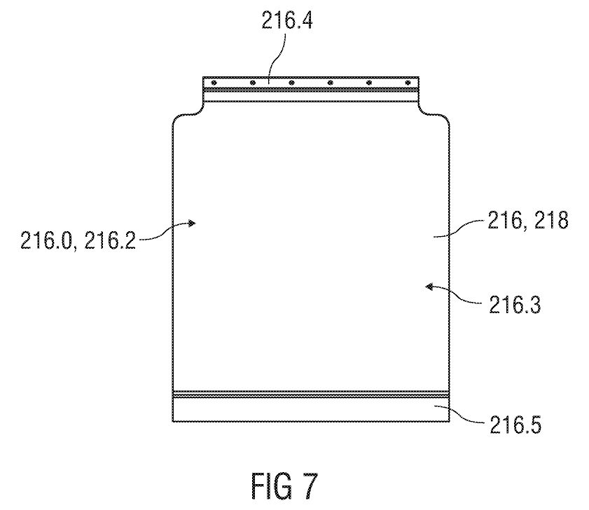

The second suspension mat 216.2 arranged under the seat cushion element 202 is, in particular, of flat design and extends, in particular, approximately horizontally. The second suspension mat 216.2 can be designed, for example, as a horizontally stretched membrane 218 with cutouts 222 (shown in FIGS. 5 and 6) and without cutouts 222 (shown in FIG. 7). The second suspension mat 216.2 supports the seat cushion element 202 in the vertical direction z. Below the recess 206 of the seat cushion element 202, the second suspension mat 216.2 can have cutouts 222, as shown in FIGS. 5 and 6.

The second suspension mat 216.2, in particular the membrane 218, can have, for example, three cutouts 222, which are arranged below the ischial tuberosities (not shown) and below the coccyx (not shown) of a user, when the membrane 218 is arranged under the seat cushion element 202 of the seat cushion arrangement 200.

The second suspension mat 216.2 can be formed, for example, as a flatly stretched, flexible membrane 218, in particular a flexible textile mat, a flexible plastic mat or the like.

For example, the support element 216, for example the second suspension mat 216.2, can have at least one first cutout 222.1 in an ischial tuberosity region 217 and at least one second cutout 222.2 in a coccyx region 219.

For example, the first cutout 222.1 can comprise at least one passage opening 222.1.0, in particular an 8-shaped passage opening 222.1.0 (not shown) or two circular, passage openings 222.1.0 spaced apart from each other (shown in FIGS. 5 and 6).

The second cutout 222.2 can, for example, be formed as a conical, triangular, u-shaped or semicircular cut portion 222.2.0, as a slot or the like. In particular, the second cutout 222.2 can be formed perpendicularly with respect to the two passage openings 222.1.0. The second cutout 222.2 can also be arranged centrally with respect to a longitudinal axis of the second suspension mat 216.2. Here, the two passage openings 222.1.0 can be arranged spaced apart from the longitudinal axis of the second suspension mat 216.2 and in a line.

In addition, the respective suspension mat 216.0 can comprise a first, for example a front, fastening unit 216.4 and a second, for example a rear, fastening unit 216.5 and a flexible support region 216.6 lying in between. For example, the respective fastening unit 216.4, 216.5 can each extend over a width of the suspension mat 216.0.

The first two cutouts 222.1, which are arranged in the ischial tuberosity region 217 below the ischial tuberosities of the user, are simultaneously arranged under the recess 206, which is arranged in the seat surface 204 of the seat cushion element 202 for receiving the relief element 210 (shown in FIG. 12) and which, for example, has an 8-shaped or loop-shaped outer contour 212 and a straight inner wall 208, as shown in FIG. 4.

FIG. 4 shows a first exemplary embodiment of the seat cushion arrangement 200 according to the invention with the first suspension mat 216.1 as a support element 216, which is arranged below the seat cushion element 202.

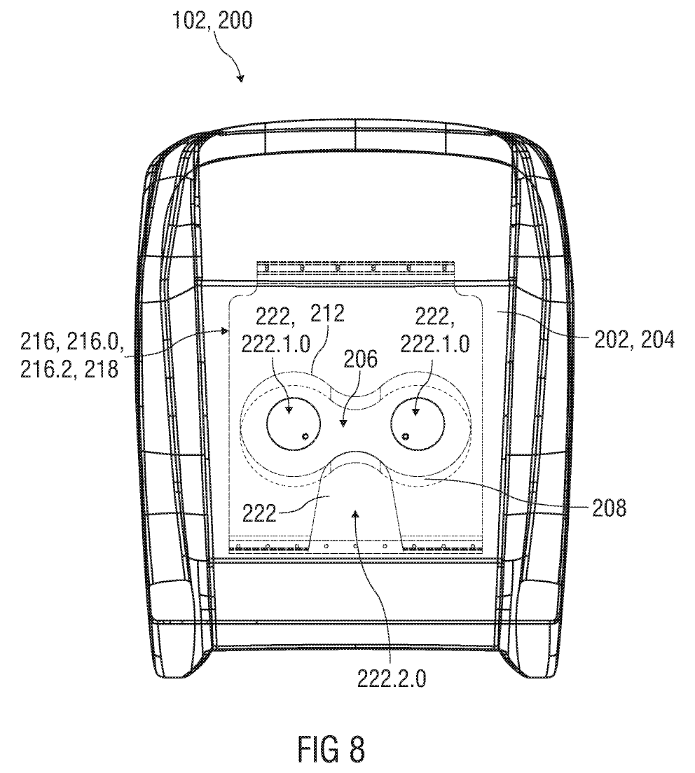

FIG. 8 shows a second exemplary embodiment of the seat cushion arrangement 200 according to the invention with the second suspension mat 216.2 as a support element 216, which is arranged below the seat cushion element 202. The passage openings 222.1.0 of the second suspension mat 216.2 are in particular smaller than the recess 206 of the seat cushion element 202.

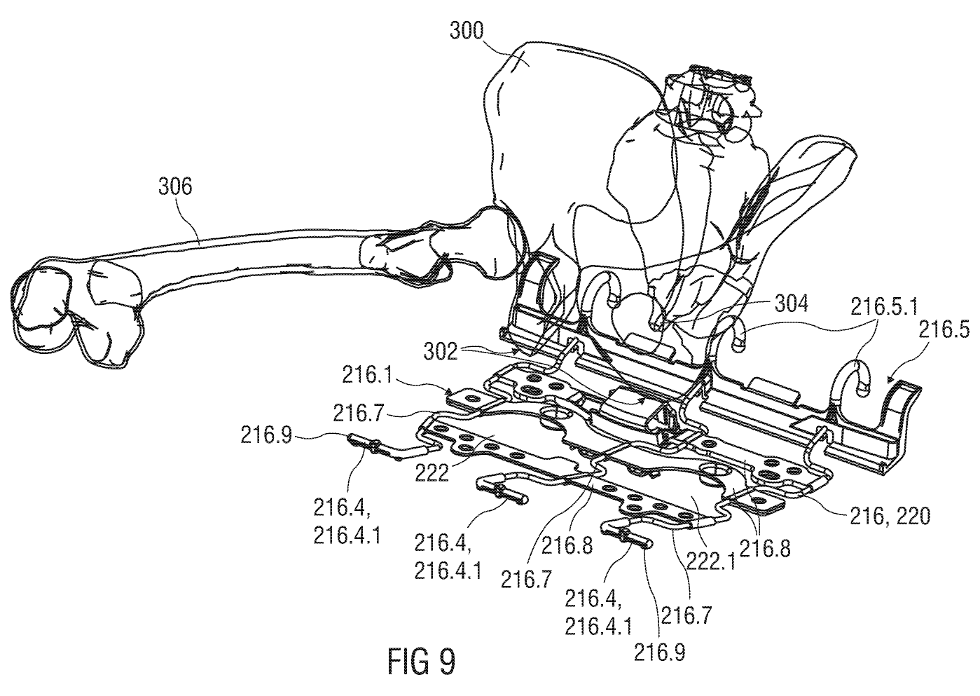

Alternatively, a third exemplary embodiment of the seat cushion arrangement 200 according to the invention can comprise both suspension mats 216.1, 216.2 as support elements 216, which are arranged below the seat cushion element 202, as shown by way of example in FIG. 9, wherein the seat cushion element 202 and the relief element 210 are not shown.

FIGS. 9 to 13 show, step by step from the bottom to the top, the structure of the third exemplary embodiment of the seat cushion arrangement 200 according to the invention, in each case in a spatial connection with anatomical features, namely the pelvis 300 with the ischial tuberosities 302 and the coccyx 304 and a femoral bone 306 of a user who has taken a seat on the seat cushion arrangement 200.

The lowest element of the seat cushion arrangement 200 is the support element 216 shown in FIG. 9 in the shape of the spring base 220 as the first suspension mat 216.1, which has first cutouts 222.1 below the ischial tuberosities 302.

The first suspension mat 216.1 can, for example, comprise a number of, in particular bent, longitudinal spring wires 216.7, which are connected to each other by cross connectors 216.8.

The second, in particular rear, fastening unit 216.5 can comprise, for example, a number of fastening hooks 216.5.1. This makes it easy to mount and dismantle the first suspension mat 216.1.

For example, a number of fastening portions 216.4.1 can be provided as the first fastening unit 216.4. The fastening portions 216.4.1 can be formed, for example, by bent-over free ends of the longitudinal spring wires 216.7. The bent-over free ends are designed, for example, as fastening hooks 216.9, for example for hooking in.

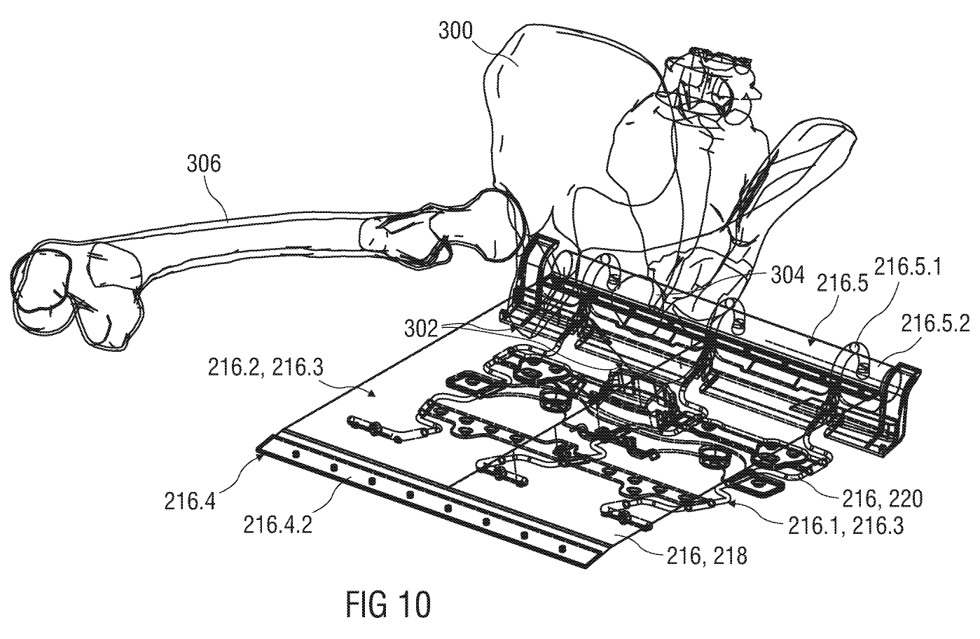

The second suspension mat 216.2 in the shape of the membrane 218, as has already been shown in FIGS. 5 and 6, can be arranged above this, as shown in FIG. 10, as a further support element 216. The second suspension mat 216.2 can, for example, comprise, as a front fastening unit 216.4, a fastening strip 216.4.2 having a number of fastening openings, for example for receiving fastening elements such as clamps, rivets, screws or the like.

As a rear fastening unit 216.5, the second suspension mat 216.2 can comprise, for example, a fastening rod 216.5.2, which is hookable, for example, into the fastening hooks 215.5.1 of the first suspension mat 216.1.

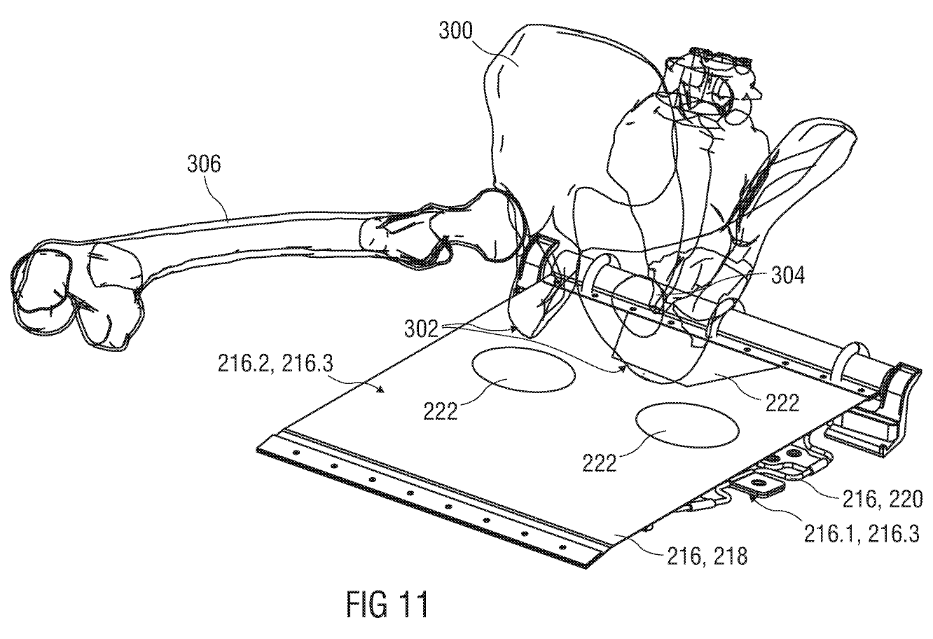

FIG. 11 shows the same view as FIG. 10, with the difference that FIG. 11 does not show the membrane 218 transparently, such that the optional cutouts 222 of the second suspension mat 216.2 are more easily recognizable.

FIG. 12 adds the relief element 210 without the seat cushion element 202 to the previous illustrations. The relief element 210 is arranged on the membrane 218 and has, for example, an 8-shaped, in particular in the form of a horizontal eight, or a loop-shaped outer contour 212 and straight side flanks 214. Optionally, the side flanks 214 can be of oblique or tapered design (not shown in greater detail). The ischial tuberosities 302 of the user are located exactly above the 8-shaped or loop-shaped relief element 210.

Finally, FIG. 13 shows how the relief element 210 is arranged in the corresponding, for example 8-shaped, recess 206 of the seat surface 204 of the seat cushion element 202.

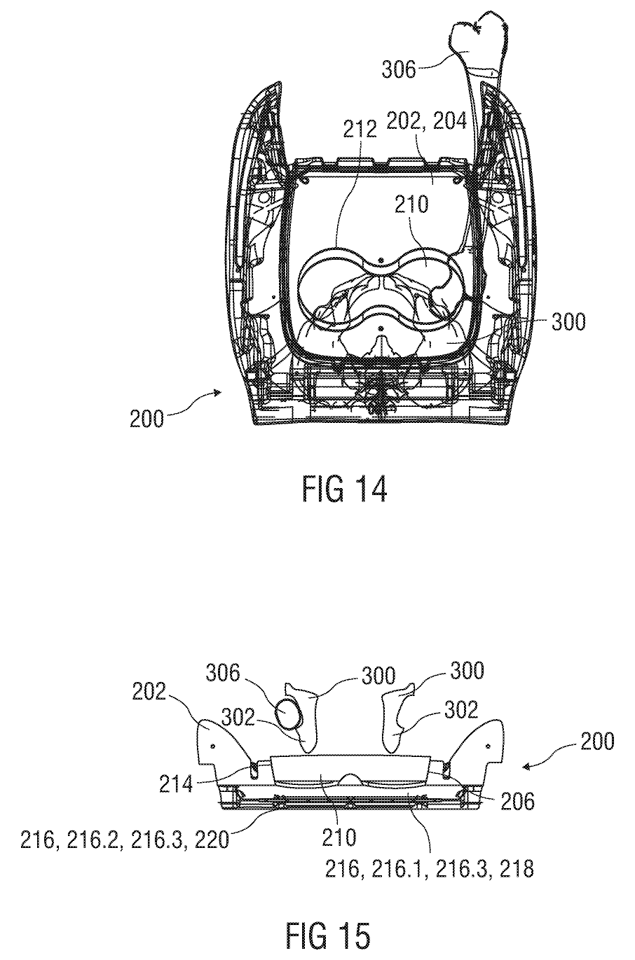

FIGS. 14 to 16 show, in each case in a plan view and in a cross-sectional illustration along the line shown in the plan view, how the seat cushion arrangement 200 according to the invention functions.

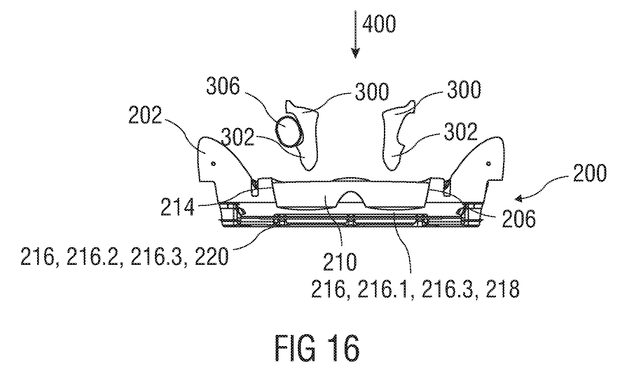

In particular, it can be clearly gathered from the cross-sectional illustrations of FIGS. 15 and 16 that the recess 206 of the seat surface 204 of the seat cushion element 202 has a straight inner wall 208 (shown in FIGS. 2 and 8), and the relief element 210 arranged therein has oblique side flanks 214. In FIG. 15, the relief element 210 is unloaded. In contrast, the relief element 210 is loaded by the weight of a user, whereby it has been shifted vertically downward in the recess 206 according to arrow 400, as shown in FIG. 16. This yielding movement of the relief element 210 achieves the situation where, when the seat cushion assembly 200 is used by a user seated on it, the maximum pressure on the surface is reduced, the total contact surface area is increased and the average pressure on the surface of the seat cushion element 202 is reduced.

To this end, the support elements 216 arranged below the seat cushion element 202 and the relief element 210, in particular the first suspension mat 216.1 and/or the second suspension mat 216.2, are additionally formed as elastic support brackets 216.3, as previously described.

### List of Designations

100 Vehicle seat

102 Seat part

104 Backrest

106 Fitting

108 Rotational axis

110 Longitudinal adjustment device

112 Rail arrangement

114 First rail element (upper rail)

116 Second rail element (lower rail)

200 Seat cushion arrangement

202 Seat cushion element

204 Seat surface

206 Recess

208 Inner wall

210 Relief element

212 Outer contour

214 Side flank

215 Support arrangement

216 Support element

216.0 Suspension mat

216.1 First suspension mat

216.2 Second suspension mat

216.3 Elastic support bracket

216.4 First fastening unit

216.4.1 Fastening portion

216.4.2 Fastening strip

216.5 Second fastening unit

216.5.1 Fastening hook

216.5.2 Fastening rod

216.6 Flexible support region

216.7 Longitudinal spring wire

216.8 Cross connector

216.9 Fastening hook

217 Ischial tuberosity region

218 Membrane

219 Coccyx region

220 Spring base

222 Cutout

222.1 First cutout

222.1.0 Passage opening

222.2 Second cutout

222.2.0 Cut portion

300 Pelvis

302 Ischial tuberosities

304 Coccyx

306 Femoral bone

400 Arrow

x Longitudinal direction

y Transverse direction

z Vertical direction

What is claimed is:

1. A seat cushion arrangement comprising:
a seat cushion element having an at least approximately horizontal seat surface, which element has at least one recess arranged in the seat surface, and
a support arrangement, wherein
the support arrangement comprises at least one support element, which is formed as a suspension mat, which is arranged below the seat cushion element, and at least one relief element, which is mounted movably at least in the vertical direction in the at least one recess of the seat cushion element.

2. The seat cushion arrangement as claimed in claim 1, wherein the recess extends in the seat cushion element in the vertical direction at least partially or completely.

3. The seat cushion arrangement as claimed in claim 1, wherein the at least one relief element has, in a plan view of the seat surface of the seat cushion element, an at least approximately 8-shaped or loop-shaped outer contour, and the recess of the seat cushion element has a corresponding, at least approximately 8-shaped or loop-shaped outer contour.

4. The seat cushion arrangement as claimed in claim 1, wherein the at least one relief element has straight side flanks, and the recess of the seat cushion element has a corresponding straight inner wall.

5. The seat cushion arrangement as claimed in claim 1, wherein the relief element is formed of an elastic plastic foam or is a cushion filled with an elastic plastic foam or a cushion filled with liquid or a gel-filled cushion.

6. The seat cushion arrangement as claimed in claim 1, wherein the relief element has a higher density or a lower density than the seat cushion element.

7. The seat cushion arrangement as claimed in claim 1, wherein the suspension mat is designed as a flat support element and forms an elastic support bracket for the seat cushion element.

8. The seat cushion arrangement as claimed in claim 1, wherein a first suspension mat is designed as a spring base.

9. The seat cushion arrangement as claimed in claim 1, wherein a second suspension mat is designed as a flatly stretched, flexible membrane.

10. The seat cushion arrangement as claimed in claim 1, wherein the respective support element has at least one cutout.

11. The seat cushion arrangement as claimed in claim 1, wherein the support element has the cutout in the region of the at least one recess of the seat cushion element.

12. The seat cushion arrangement as claimed in claim 1, wherein the support element has at least one first cutout in an ischial tuberosity region and at least one second cutout in a coccyx region.

13. The seat cushion arrangement as claimed in claim 1, wherein the support element comprises a first fastening unit and a second fastening unit as well as a flexible support area lying in between.

14. A vehicle seat with a seat part and a backrest, in which the seat part has a seat cushion arrangement as claimed in claim 1.

15. The vehicle seat as claimed in claim 14, wherein a first suspension mat and/or a second suspension mat are/is arranged below the seat cushion element.
